(19) United States
(12) Patent Application Publication
(10) Pub. No.: US 2007/0158124 A1
(43) Pub. Date: Jul. 12, 2007

(54) Two-way assist gas spring and retractable spring assembly

(75) Inventors: Richard E. Bluemle, Columbia, SC (US); Walter Douglas Bauman, Wixom, MI (US)

Correspondence Address: CARLSON, GASKEY & OLDS, P.C., 400 WEST MAPLE ROAD, SUITE 350, BIRMINGHAM, MI, 48009, US

(73) Assignee: AVM, Inc.

(21) Appl. No.: 11/330,272

(22) Filed: Jan. 11, 2006

(51) Int. Cl. B62D 31/00

(52) U.S. Cl. 180/89.1

(57) ABSTRACT

A gas spring and a retractable device cooperate to provide a two-way assist mechanism for controlling movement of a body panel. The retractable device includes a spring assembly received within a tube that is attached to the gas spring. The body panel is attached to a vehicle frame with a pivotal connection. One of the gas spring and retractable device is connected to the vehicle frame and the other of the gas spring and retractable device is connected to the body panel. The retractable device acts as a solid link as the body panel moves from a closed position towards an open position. Once a center of gravity of the body panel rotates beyond the pivotal connection, the retractable device resists further movement of the body panel until a fully open position is achieved.

### TECHNICAL FIELD

The subject invention relates to gas spring and retractable assembly that provides a two-way assist for a wide range of movement of a vehicle member.

### BACKGROUND OF THE INVENTION

Gas spring assemblies are used to control movement of one component relative to another component. For example, a gas spring assembly is used to control movement of a vehicle body panel, such as a liftgate, hood, or trunk lid, relative to a vehicle body member. The gas spring assembly is moveable between a fully extended position and a fully compressed position, and assists an operator with lifting and closing the vehicle body panel, which is typically pivotally connected via a hinge to the vehicle body member.

In one known example, the gas spring assembly is used to control movement of a vehicle hood between an open and a closed position. The vehicle hood has a hinged connection located near a front bumper and the hood is pivoted from the closed position, away from a vehicle windshield, to an open position that exposes an engine compartment. The vehicle hood defines a center of gravity that passes over a point vertically above the hinged connection.

The gas spring assembly assists a user with moving the vehicle hood from the closed position to the open position. In a fully open position the vehicle hood is typically pivoted such that the center of gravity of the vehicle hood moves past the hinged connection. The gas spring assembly typically operates with a compression force acting on the gas spring assembly, but as the center of gravity of the vehicle hood moves over the hinged connection the gas spring assembly is subjected to extension forces as opposed to compression forces. This is undesirable as a user has to overcome the weight of the vehicle hood and the extension force acting on the gas spring assembly in order to move the hood from the fully open position toward a closed position.

Thus, there is a need for a gas spring assembly that can provide assistance and resistance as needed with movement of a vehicle body panel when the center of gravity of the vehicle body panel has moved beyond a pivotal connection point.

### SUMMARY OF THE INVENTION

A gas spring and a retractable device cooperate to provide a two-way assist mechanism for controlling movement of a vehicle body member. The retractable device includes a spring assembly received within a tube that is attached to the gas spring. The vehicle body member is attached to a vehicle frame with a pivotal connection. One of the gas spring and retractable device is connected to the vehicle frame and the other of the gas spring and retractable device is connected to the vehicle body member.

The retractable device acts as a solid link as the vehicle body member moves from a closed position towards an open position. Once a center of gravity of the vehicle body member moves beyond the pivotal connection, the retractable device resists further movement of the vehicle body member until a fully open position is achieved. The retractable device includes a resilient member that extends to store energy and provide resistance once the vehicle body member has moved beyond the pivotal connection. The retractable device assists movement of the vehicle body member as the body panel is rotated from the fully open position toward the closed position. Assistance is provided by the energy stored in the resilient member.

These and other features of the present invention can be best understood from the following specification and drawings, the following of which is a brief description.

### BRIEF DESCRIPTION OF THE DRAWINGS

FIG. 1 is a schematic view of a vehicle having a gas spring assembly incorporating the subject invention.

FIG. 2 is a perspective view of a gas spring and retractable device assembly incorporating the subject invention.

FIG. 3 is a cross-sectional view of the assembly of FIG. 2.

FIG. 4 is a perspective view of another example of a gas spring and retractable device assembly incorporating the subject invention.

FIG. 5 is a cross-sectional view of the assembly of FIG. 4.

### DETAILED DESCRIPTION OF THE PREFERRED EMBODIMENT

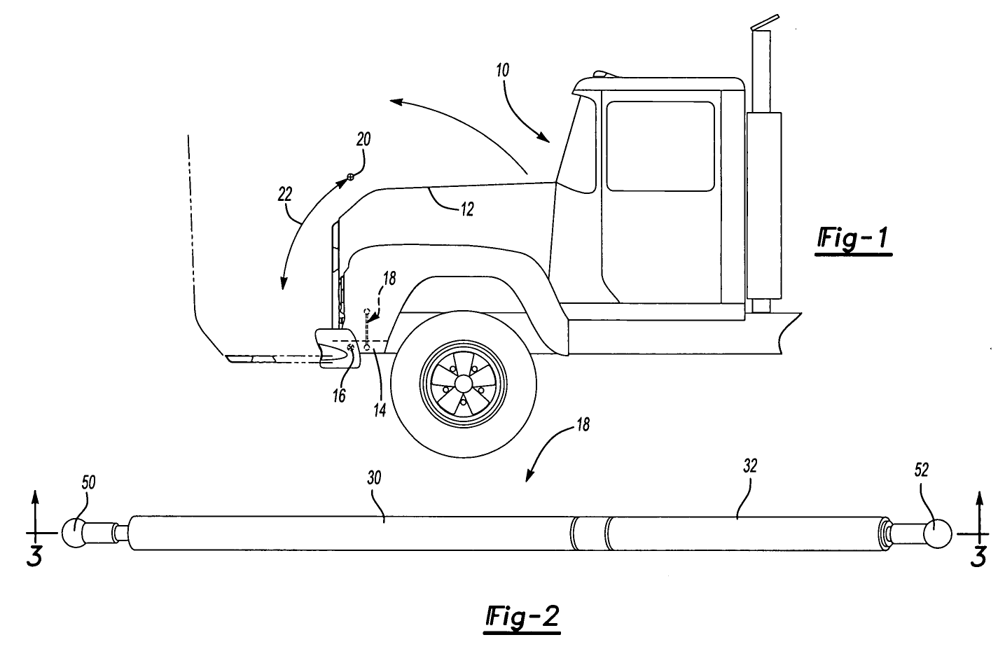

FIG. 1 shows a vehicle 10 having a body member 12 that is movable relative to a frame member 14. In the example shown, the body member 12 comprises a vehicle hood, however, the body member 12 could also comprise a liftgate, trunk lid, etc. The body member 12 is pivotally attached at a connection 16 to the frame member 14. A gas spring and retractable device assembly 18 cooperate to control movement of the body member 12 as the body member 12 pivots about the connection 16 between open and closed positions.

Any type of connection can be used to achieve pivotal or rotational movement of the body member. One type of connection is a hinge. The body member 12 defines a center of gravity 20. Typically, when fully open, the center of gravity 20 of the body member 12 is at a vertical position above the connection 16. However, certain applications rotate or pivot the body member 12 beyond the connection 16 to achieve a fully open position.

In the example mounting configuration shown in FIG. 1, the gas spring and retractable device assembly 18 move the body member 12 such that the center of gravity 20 moves past the connection 16 as indicated by arrow 22. The body member 12 starts out in a fully closed position, shown by the solid lines, and can then be moved to a partially open position where the center of gravity 20 is located generally above the connection 16. As the body member 12 is moved to a fully open position, indicated by dashed lines, the center of gravity 20 is moved beyond the connection 16.

Typically, when a gas spring alone is used to control movement in such a configuration, the gas spring is initially subjected to a compression force as the body member 12 moves from the closed position towards the partially open position. As the center of gravity 20 passes over the connection 16, the gas spring moves from compression forces to extension forces. In this situation, an operator would have to overcome the weight of the body member 12 in addition to overcoming the force of the gas spring, in order to move the body member 12 from the fully open position back towards the closed position.

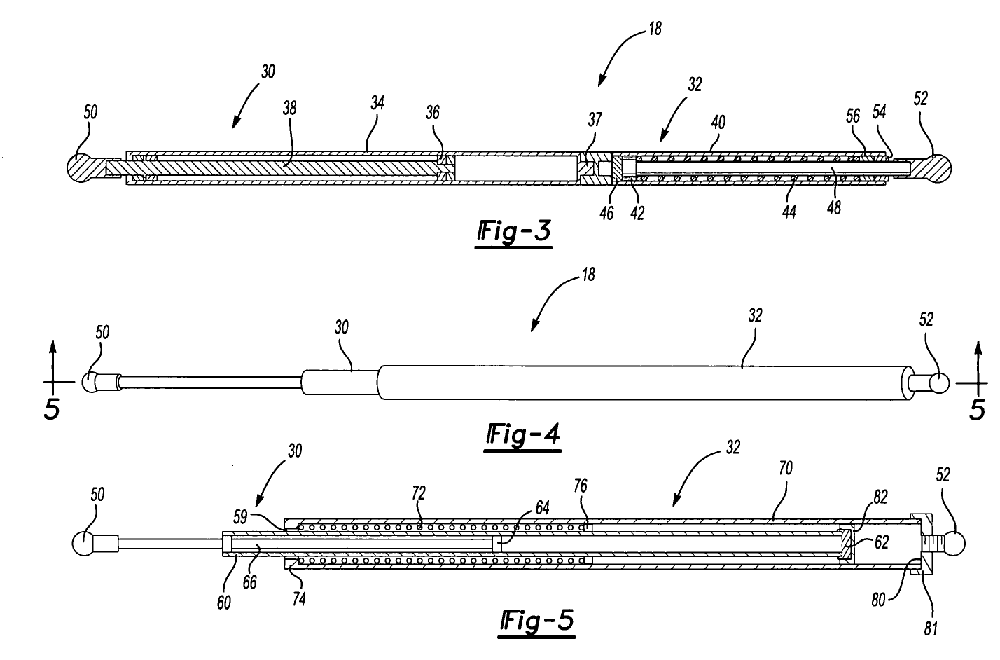

In order to overcome this problem, the subject invention incorporates a retractable device into the gas spring assembly. One example of the gas spring and retractable device assembly 18 is shown in FIGS. 2-3. The gas spring and retractable device assembly 18 includes a gas spring portion 30 and a retractable portion 32.

The gas spring portion 30 includes an outer tube or cylinder 34 with an end cap 37 that encloses one end of the cylinder 34 near the retractable portion 32. A piston 36 is received within the cylinder 34 and is coupled to a rod 38 as known. The rod 38 moves the piston 36 between compression and extension positions. The piston 36 and rod 38 meter fluid flow within the cylinder 34 as known. Any type of gas spring assembly can be use for the gas spring portion 30.

The retractable portion 32 includes a tube 40, a piston 42 received within the tube 40, a resilient member 44 coupled to the piston 42, and a piston end stop 46. The resilient member 44 is preferably a coil spring, however, other resilient mechanisms could also be used. The piston end stop 46 is positioned adjacent the end cap 37 of the gas spring portion 30. The piston end stop 46 is shown as a separate piece that is received within the tube 40; however, a spring member, or a bead or other formation in a wall of the tube 40 could also define the piston end stop 46.

A rod 48 is coupled to the piston 42 and is guided within the tube 40 by a guide bushing 54 fixed to an end of the tube 40. Optionally, a washer 56 positioned axially adjacent to the guide bushing 54 is used for wiping rod 48. The washer 56 is preferably made from a low-friction material such as Teflon®, for example.

A first connector 50 is attached to the rod 38 of the gas spring portion 30 and a second connector 52 is attached to the rod of the retractable portion 32. One of the first 50 and second 52 connectors is attached to the frame member 14 and the other of the first 50 and second 52 connectors is attached to the body member 12.

As the body member 12 is moved from the closed position towards the partially open position, the resilient member 44 is bottomed out within the tube 40. In a bottomed out position, the resilient member 44 is at either a solid height or at a predetermined stopping height. The resilient member 44 is in a compressed configuration and the piston 42 is in abutting engagement with the piston end stop 46. The gas spring portion 30 provides the assisting movement as the body member 12 is moved from the closed position toward the partially open position, while the retractable portion 32 acts as a solid link. Once the center of gravity 20 passes the connection 16 the resilient member 44 resists further movement of the body member 12. The resilient member 44 extends to slow movement of the body member 12 in a controlled manner until the fully open position is achieved.

Optionally, a piston package (not shown) could be used in combination with the resilient member 44 to control falling movement. The resilient member 44 would reduce the speed of the fall, and the piston package, along with associated seals and oil, would control the movement. The piston package could be an extension, compression, or dual damper configuration.

Also optionally, a damper bushing package (not shown) could be used to provide desired sealing characteristics. The damper bushing package could include a combination of components such as an o-ring, bushing, Teflon® material, a seal assembly, and a retaining plate, for example. It should be understood that this is just one example combination, and that other combinations of such components could also be used to form the damper bushing package.

When the body member 12 is returned from the fully open position to the closed position, the resilient member 44 assists the operator with lifting of the body member 12. The resilient member 44 is compressed until the piston 42 hits the piston end stop 46.

Another example of the gas spring and retractable device assembly 18 is shown in FIGS. 4-5. This embodiment operates in a manner similar to that shown in FIGS. 2-3, however, the resilient member 44 is mounted externally to the gas spring portion 30.

The gas spring portion 30 includes an outer tube or cylinder 60 with an end cap 62 that encloses one end of the cylinder 60. A piston 64 is received within the cylinder 60 and is coupled to a rod 66 as known. The rod 66 moves the piston 64 between compression and extension positions. Again, any type of gas spring assembly can be use for the gas spring portion 30.

The retractable portion 32 includes a tube 70 that is mounted to an external surface of the cylinder 60. A resilient member 72 is positioned between the tube 70 and the cylinder 60. The resilient member 72 reacts between an internal shoulder 74 of the tube 70 at one end and an outer shoulder 76 of the cylinder 60 at an opposite end. An optional bushing 59 could be positioned between the internal shoulder 74 and cylinder 60.

As the body member 12 is moved from the closed position towards the partially open position, the resilient member 72 is compressed between the internal shoulder 74 and the outer shoulder 76. The gas spring portion 30 provides the assisting movement as the body member 12 is moved from the closed position toward the partially open position, while the retractable portion 32 acts as a solid link. Once the center of gravity 20 passes the connection 16 the resilient member 72 resists further movement of the body member 12 by being extended within the tube 70. When the body member 12 is returned from the fully open position to the closed position, the resilient member 72 assists the operator with lifting of the body member 12. The end cap 62 of the gas spring portion 30 bottoms out at a stop surface 80. The stop surface 80 is shown as being the end of tube 70, however, the position of the stop surface 80 could be defined by a separate piece, a spring member or a bead or formation in a wall of the tube 70. Further, a guide member 82 assists with guiding movement of the cylinder 60 within the tube 70.

In the configuration shown in FIGS. 4-5, the first connector 50 is attached to the rod 66 of the gas spring portion 30 and the second connector 52 is attached to end cap 81 of the tube 70 of the retractable portion 32. Again, one of the first 50 and second 52 connectors is attached to the frame member 14 and the other of the first 50 and second 52 connectors is attached to the body member 12.

In either configuration, the subject gas spring and retractable device assembly 18 assists movement of the body member 12 to a point where the center of gravity 20 is close to or just beyond a point where the center of gravity crosses over the connection 16. When the gas spring portion 30 is fully extended in this position, the resilient member 44, 72 of the retractable portion 32 starts to extend due to an external force or weight of the body member 12. The resilient member 44, 72 resists this force, i.e. slows the movement in a controlled manner, to further assist the operator. The position of the center of gravity in relation to the connection can vary depending on different vehicle applications. The gas spring and retractable device assembly 18 can be designed to accommodate these variations by varying the type of gas spring and/or varying the configuration, size, etc. of the resilient member to provide controlled resistance and assistance as needed.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A two-way assist gas spring assembly comprising:
a gas spring assembly adapted to assist movement of a vehicle body member from a first position to a second position; and
a retractable device coupled to said gas spring assembly wherein said retractable device resists movement of the vehicle body member as the vehicle body member moves from the second position to a third position.

2. The two-way assist gas spring assembly according to claim 1 wherein said first position comprises a closed position, said second position comprises a partially open position, and said third position comprises a fully open position.

3. The two-way assist gas spring assembly according to claim 2 wherein said retractable device assists movement of the vehicle body member as the vehicle body member moves from said third position to said second position.

4. The two-way assist gas spring assembly according to claim 2 wherein the vehicle body member is adapted for pivotal connection to a vehicle frame, the vehicle body member defining a center of gravity and wherein movement of the vehicle body member is defined as being between said first and second positions as the center of gravity moves from an initial closed position toward the pivotal connection to the partially open position and is defined as being between the second and third positions as the center of gravity moves beyond the pivotal connection to the fully open position.

5. The two-way assist gas spring assembly according to claim 4 wherein said gas spring assembly includes a first connector adapted for connection to one of the vehicle frame and vehicle body member and wherein said retractable device includes a second connector adapted for connection to the other one of the vehicle frame and vehicle body member.

6. The two-way assist gas spring assembly according to claim 5 wherein the vehicle body member comprises a hood.

7. The two-way assist gas spring assembly according to claim 5 wherein said retractable device comprises a spring received within a cylinder, said spring being bottomed out as the vehicle body member moves from the first position to the second position and said spring being extendable to resist movement as the vehicle body member moves from the second position to the third position.

8. The two-way assist gas spring assembly according to claim 7 wherein said cylinder includes an end stop to define a bottomed out position for said spring.

9. A two-way assist gas spring assembly comprising:
a gas spring assembly adapted to assist movement of a vehicle body member from a first position to a second position, said gas spring assembly including a gas spring cylinder, a gas spring piston received within said gas spring cylinder and a gas spring rod coupled to said gas spring piston to move said gas spring piston between extension and compression positions; and
a retractable device coupled to said gas spring assembly, said retractable device including a tube, a retractable piston received within said tube, a resilient member cooperating with said retractable piston, and a retractable rod coupled to said retractable piston such that said resilient member resists movement of the vehicle body member as the vehicle body member moves from the second position to a third position.

10. The two-way assist gas spring assembly according to claim 9 wherein the vehicle body member is adapted for pivotal connection to a vehicle frame, the vehicle body member defining a center of gravity, and wherein movement of the vehicle body member is defined as being between said first and second positions as the center of gravity moves from the first position toward the pivotal connection to the second position, and is defined as being between the second and third positions as the center of gravity moves from the second position beyond the pivotal connection to the third position.

11. The two-way assist gas spring assembly according to claim 10 wherein the first position comprises an initial closed position, the second position comprises a partially open position, and the third position comprises a fully open position.

12. The two-way assist gas spring assembly according to claim 11 wherein the resilient member assists movement of the vehicle body member as the vehicle body member is moved from the fully open position toward the closed position.

13. The two-way assist gas spring assembly according to claim 10 including a first connector coupled to said gas spring rod and adapted for connection to one of a vehicle frame and vehicle body member and a second connector coupled to said retractable rod and adapted for connection to the other one of the vehicle frame and vehicle body member.

14. The two-way assist gas spring assembly according to claim 9 wherein said tube of said retractable device includes an end stop to define a bottomed out position for said resilient member as the vehicle body member moves from the first position to the second position.

15. A vehicle component assembly comprising:
a vehicle frame member;
a vehicle body member movable relative to said vehicle frame member; and
a two-way assist gas spring assembly including a gas spring assembly that assists movement of the vehicle body member from a first position to a second position, and a retractable device cooperating with the gas spring assembly such that said retractable device resists movement of the vehicle body member as the vehicle body member moves from the second position to a third position.

16. The vehicle component assembly according to claim 15 wherein said gas spring assembly includes a first connector connected to one of the vehicle frame member and vehicle body member, and wherein said retractable device includes a second connector connected to the other one of the vehicle frame member and vehicle body member.

17. The vehicle component assembly according to claim 16 wherein said retractable device comprises a spring received within a cylinder, said spring being bottomed out as the vehicle body member moves from the first position to the second position and said spring being extendable to resist movement as the vehicle body member moves from the second position to the third position.
